(19) United States
(12) Patent Application Publication
(10) Pub. No.: US 2010/0193587 A1
(43) Pub. Date: Aug. 5, 2010

(54) Interactive Printed Document System

(76) Inventor: John Boucard, Pasadena, CA (US)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/365,014

(22) Filed: Feb. 3, 2009

(51) Int. Cl. G06K 7/10

(52) U.S. Cl. 235/454

(57) ABSTRACT

An interactive printed document system includes a printed document that generates output data for a portable memory device that is removably coupled to the printed document. The printed document includes an embedded component that can be activated to generate the output data. The information received from the printed document can be decoded to determine a link that points to online content provided by a server over a network. A user of the portable memory device can access the online content using the link through a computing device that is connected to the network. The embedded component can be printed with resistive ink or can be embedded with radio frequency identifier (RFID) tags.

### FIELD OF THE INVENTION

The embodiments of the present invention relate to a printed document system that interacts with users. Specifically, the embodiments of the invention relate to a printed document that transmits data to a portable memory device placed on the printed document to allow a user of the portable memory device to access a link associated with the printed document.

### BACKGROUND OF THE INVENTION

Printed documents, such as books, magazines and catalogs, have been used to circulate information for hundreds of years. The development of digital media has not entirely replaced the role of printed documents. Printed documents can be easily transported, and can be read without the need of a computer or a network connection. However, printed documents lack interactive features that can be offered by online document sites. For example, an online catalog can have a product link embedded in the picture of each product such that a reader can click on the picture to view more information. A printed catalog does not have this interactive feature. A reader of the printed catalog will have to search for the product link or write down the link on a piece of paper (if the link is provide in the printed catalog), and enter the link in a browser to receive additional product information online. The lack of convenient access to online information reduces the effectiveness of the printed documents.

Similar problems exist in other types of printed documents. A reader interested in obtaining more information about a printed book (e.g., information about a book club, a character in the book, the related book series, etc.) usually has to rely on a search engine to search the Internet for the information. A printed book does not have an embedded link as in an online book that can be clicked by a reader with a mouse. Thus, the use of printed documents separates the reading experience from the interactive experience that can be obtained from web-based media.

Some printed documents are used to collect data. In some scenarios, the data (e.g., answers to a questionnaire or a test) written on a printed document is manually processed to compute scores or statistics. For example, students who answer the questions in their workbooks will turn in the workbooks to their teacher for grading. Typically, either the answers or the grades are manually entered into a computer system for record keeping. Manual data input is error prone and time consuming, and, therefore, is highly undesirable.

### SUMMARY

The embodiments of the invention include an interactive printed document system that uses a portable memory device to collect user input data from a printed document. The data received from the printed document can be decoded to determine a link that points to online content relating to or supplementing the content of the printed document. A user of the portable memory device can access the online content using the link through a browser on a networked computing device.

The portable memory device is removably coupled to the printed document. For example, the portable memory device can be placed on each page of the printed document as the reader reads through the pages. In one embodiment, the printed document includes an embedded component that can be activated to generate an output. The embedded component can be a circuit element printed with resistive ink or can be a radio frequency identifier (RFID) tag. The embedded component can be activated by a user touching or pressing pre-determined locations of the printed document. Each pre-determined location embeds a switch, which is electrically closed by the touch of the user. Touching the switch is associated with selecting an item from a location of the printed document where the switch is embedded. In response to the user's touch, the printed document generates an output that identifies the location selected by the user. The location of the printed document and other identifying information can be used to determine a link to online content. A user can click the portable memory device to record the output generated by the printed document.

### BRIEF DESCRIPTION OF THE DRAWINGS

Embodiments are illustrated by way of example and not by way of limitation in the figures of the accompanying drawings, in which like references indicate similar elements. It should be noted that references to “an” or “one” embodiment in this disclosure are not necessarily to the same embodiment, and such references mean at least one.

FIG. 1A is a diagram of one embodiment of a printed document.

FIG. 1B is a diagram of one embodiment of a printed document cover.

FIG. 2A is a diagram of one embodiment of a printed game board.

FIG. 2B is a diagram of another embodiment of a printed game board.

FIG. 3 is a diagram of one embodiment of a printed yearbook.

FIG. 4 is a block diagram of a networked system for an interactive printed document system.

FIG. 5 is a flow diagram of one embodiment of a process for a portable memory device to collect data from a printed document.

FIG. 6 is a diagram of one embodiment of a process for a user of a portable memory device to obtain access to online content associated with a printed document.

FIG. 7 a diagram of one embodiment of a portable memory device.

### DETAILED DESCRIPTION

A method and system for an interactive printed document system is described. In one embodiment, a printed document includes an embedded component that can be activated to generate an output. The output is received by a portable memory device, which is removably coupled to the printed document. The information received from the printed document can be decoded to determine a link that points to online content provided by a server over a network. A user of the portable memory device can access the online content using the link through a computing device that is connected to the network.

Examples of the printed document include a comic book, photo album, year book, catalog, newspaper, magazine, form, test, textbook, or game board. The printed document can be printed with resistive ink or can be embedded with radio frequency identifier (RFID) tags. When a user touches a location of the printed document where a switch is embedded, an item printed on the location of the printed document is selected and an associated embedded component of the printed document is activated. The activation causes the printed document to generate output data that includes identifiers of the locations selected by the user and other identifying information. The portable memory device captures the output data via a ‘quick-touch’ or ‘quick-click’ capture mechanism. A user can click the capture mechanism to record the output data.

The examples and embodiments described herein below are related to an interactive printed document system. However, one skilled in the art would understand that the components, techniques and principles described herein with regard to the printed document data is also applicable to other similar types of data and systems including gaming data, brand loyalty data, social networking data, educational program data, group data, membership data, institutional data, government data and similar data. For the sake of clarity, the embodiments and examples are given in relation to the printed document data; however, one skilled in the art would understand that the other types of data can also be managed using the same methods and structures.

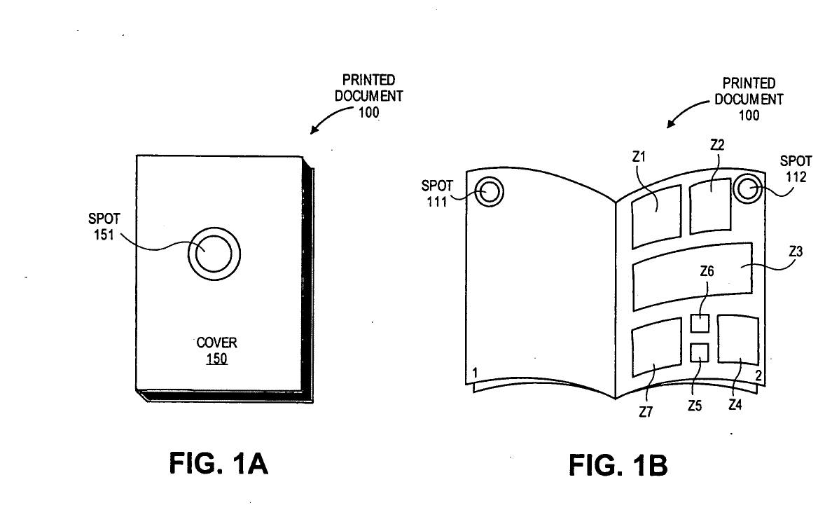

FIGS. 1A and 1B are diagrams of one embodiment of a printed document 100. FIG. 1A shows the printed document 100 as a closed book, and FIG. 1B shows the printed document 100 as an open book. The printed document may be a comic book, photo album, year book, catalog, newspaper, magazine, form, test, textbook, or game board, or any other printed publication. The printed document 100 has a spot 151 on the cover 150, and a spot on each page (e.g., spot 111 on page 1 and spot 112 on page 2). The locations of the spots 151, 111, 112 can be anywhere on the page and are not limited to the embodiments as shown. The spots 151, 111, 112 may be identified by a pre-determined pattern, such as a double circle or other easily recognizable patterns. Spots 151, 111 and 112 indicate the location on which a portable memory device can be placed.

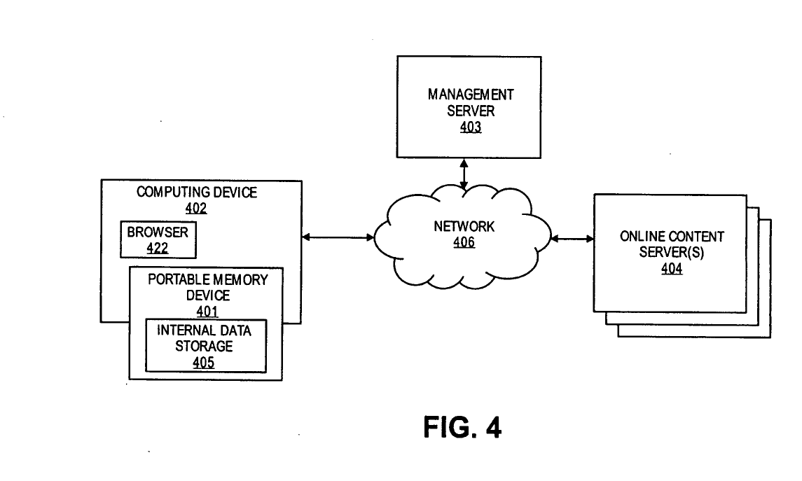

The portable memory device can be used to record embedded information in the printed document 100, such as a book ID and page ID. The portable memory device can also be used to record information entered by a user, such as a user's selection of one or more pages, items on a page, zones within a page, points, or fields in the printed document. In one embodiment, the portable memory device includes a clickable mechanism that can be clicked to start recording the data transmitted from the printed document 100. The portable memory device may have the same shape as the shape of the spots 151, 111 and 112 (e.g., a circular disk shape). However, it is understood that the portable memory device can have any shape, any size and any form factor that can be conveniently placed on a printed document. Operation and components of the portable memory device will be described in greater detail with reference to FIGS. 4-6.

In one embodiment, the printed document 100 includes embedded components printed by resistive ink. Each embedded component is a circuit element that receives power from the portable memory device. The circuit element may contain one or more open switches that can be closed (i.e., activated) by a user's touch. When a combination of the switches on a printed page is activated, the embedded component generates an output that indicates an identifier. For example, an output generated by an embedded component on the cover 150 can include a master ID to identify the book and an output generated by an embedded component on each following page can include a page ID to identify the page number.

Referring to FIG. 1B, in one embodiment shown on page 2 of the printed document 100, the page is divided into multiple zones (Z₁-Z₇). Each zone is identified by a zone ID. A user can select one or more zones to indicate his interest in the items shown in those zones. The selection of a zone can be accomplished by the user touching the zone (e.g. anywhere in the zone or a pre-designated location in the zone) with a finger or a stylus. Each zone is embedded with an open switch. When a user touches the switch, the switch is closed to cause the printed document 100 to generate an output. The user can click the portable memory device to receive the output, which includes zone IDs identifying the zones selected by the user in addition to the master ID and page ID.

The printed document output data, including the master ID, page ID and zone ID, can be used to determine a link that points to online content. The link determination may also use a device ID that identifies the portable memory device. The link can be determined by a processing element of the portable memory device. Alternatively, the portable memory device may encode and transmit the IDs to a pre-designated management server, which determines the link using the IDs and sends the link back to the user. The link points to an online content site, such as a product information site, a photo reprint site, a comic book enthusiasts' site, a record keeping site, an educational site, or other online sites that are associated with the printed document 100.

In some embodiments, some or all of the embedded components in the printed document 100 may be RFID tags that contain the identifiers to identify a book, a page and a zone. The portable memory device uses an RF near field communication mechanism to read the embedded RFID tags. When a user clicks the portable memory device, an RF signal is transmitted from the portable memory device to activate the embedded the RFIDs. The portable memory device reads the activated RFIDs and stores the IDs in internal storage for determination of a link.

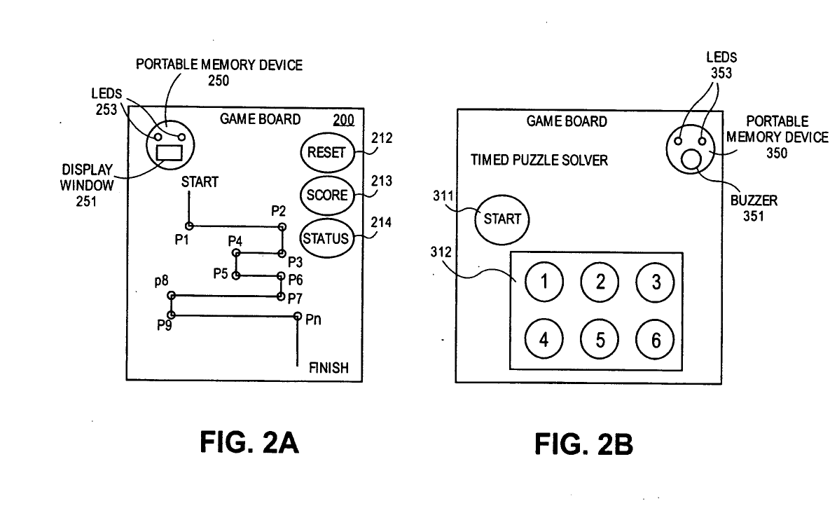

FIG. 2A is a diagram of one embodiment of a printed game board 200 that includes a sequence of points (p₁-pₙ) to be connected by a player. The printed game board 200 includes a spot on which a portable memory device 250 can be placed. The printed game board 200 also contains one or more printed buttons, including a reset button 212, a score button 213 and a status button 214. To start the game, a player can click the portable memory device 250 to start recording. The player can touch the points (p₁-pₙ) in a sequence to play the game. During the game, the player can select the reset button 212 to reset the game, the score button 213 to determine his scores, and the status button 214 to view the status of the game (e.g., from a display window 251 on the portable memory device 250). The portable memory device 250 includes one or more light-emitting diodes (LEDs) 253 that indicate whether a player's input has been detected. For example, one of the LEDs 253 may be blinking green to indicate that the portable memory device 250 has detected a point being selected by the player, and another of the LEDs 253 may be blinking red to indicate that the portable memory device 250 has not detected a touch or a location of the player's touch cannot be determined. The player can repeat data entry when negative feedback (e.g., a blinking red LED) is received. When the game is finished, the player can click the portable memory device 250 to stop recording.

In one embodiment, each point (p₁-pₙ) and each printed button (212-214) indicates a location where a switch is embedded. The switch is part of a circuit element printed with resistive ink. Every time the user touches a point or a button, the associated switch is activated. After the player completes the game, the data collected by the portable memory device 250 can be used to determine a link pointing to online content that provides additional information about the game. The collected data can be decoded by the portable memory device 250 to determine the link, or can be encoded and forwarded by the portable memory device 250 to a server (e.g., a pre-designated management server) for link determination. Using the link, the player can be connected to an online content server to obtain additional information about the game. The online content server site may include a mechanism that unlocks other online content, e.g., other virtual games or puzzles.

FIG. 2B is a diagram of another embodiment of a printed game board 300 that includes a puzzle. In the embodiment shown in FIG. 2B, the printed game board 300 is a timed puzzle game. The player can click a portable memory device 350 placed on the printed game board 300 to start recording. To start the game, a player can press a printed start button 311 to start a timer. The player then proceeds to select one or more of the numbered buttons 312 to solve a puzzle according to a given instruction. In one embodiment, each numbered button 312 indicates a location where a switch is embedded. The switch is part of a circuit element that is printed with resistive ink. Every time the user touches one of the numbered buttons 312, the associated switch is activated.

During the game, the portable memory device records the physical interactions between the player and the puzzle. One or more LEDs 353 on the portable memory device 350 can be used to indicate whether each button press is detected successfully. For example, a blinking green LED indicates that a button press is detected by the portable memory device 250 and recorded successfully, and a blinking red LED indicates that the portable memory device 250 is waiting for an input, or a touch on the surface of the game board 300 is detected but the pressed button number cannot be determined. When a pre-determined time limit is reached, a buzzer 351 (e.g., a piezoelectric buzzer) in the portable memory device 350 goes off to indicate that the game is over and the data recording has stopped. The data collected by the portable memory device 350 can be used to determine a link pointing to online content that provides additional information about the game. The collected data includes a sequence of IDs (e.g., a game ID and button IDs), and may also include the associated timing. The collected data can be decoded by the portable memory device to determine the link, or can be encoded and forwarded by the portable memory device 350 to a server (e.g., a pre-designated management server) for link determination. The player can then use the link to connect to a site hosted by an online content server. Data transmitted to the online content server from the portable memory device may include the portable memory device ID and the sequence of IDs collected during the game. Based on the IDs transmitted from the portable memory device 350, the online content server can unlock other content (e.g., virtual games and puzzles) for access by the player.

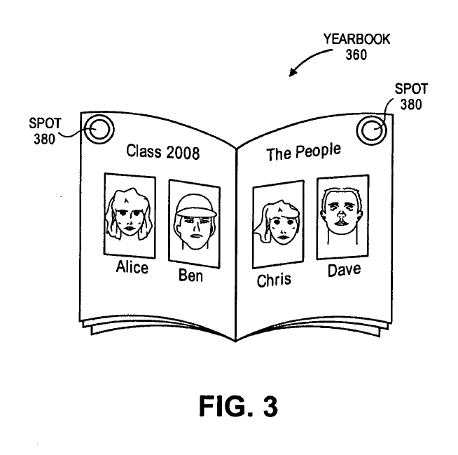

FIG. 3 is a diagram of one embodiment of a printed yearbook 360. In this embodiment, the yearbook 360 includes photos of the students in a class. Each photo is identified by an embedded photo ID. A reader of the yearbook 360 can select one or more photos to indicate his interest in viewing additional information about the persons in the selected photos. The selection of a photo can be accomplished by the reader touching the photo (e.g. anywhere on the photo) with a finger or a stylus. Each photo is embedded with an open switch. When a reader touches the switch, the switch is closed to cause the yearbook 360 to generate an output. The reader can click the portable memory device, which is placed on a predetermined spot on the yearbook 360 (e.g., a spot 380 on the page of the selected photo) to receive the output, which includes photo IDs identifying the photos selected by the reader. Similar to the printed document 100 of FIG. 1, the yearbook 360, or the particular copy of the yearbook 360, can be identified by a master ID and each page of the yearbook 360 can be identified by a page ID.

The yearbook output data, including the master ID, page ID and photo ID, can be used to determine a link that points to online content. The link determination may also use a device ID that identifies the portable memory device. The link can be determined by a processing element of the portable memory device. Alternatively, the portable memory device may encode and transmit the IDs to a pre-designated management server, which determines the link using the IDs and sends the link back to the reader. The link points to an online content site associated with the selected photo. For example, a selected photo of a student may be associated with online contents such as the student's personal websites, social websites, recommended websites, or other online sites that are associated with the student in the selected photo.

In some embodiments, each copy of the yearbook 360 includes an RFID tag that identifies the person that owns the copy of the yearbook 360. The RFID tag can be embedded on the front cover, the back cover, or anywhere in the yearbook 360. Thus, a first person can use an RF near field communication mechanism on his portable memory device to read the embedded RFID tag on a second person's yearbook 360. When the first person clicks the portable memory device, an RF signal is transmitted from the portable memory device to activate the embedded the RFID tag on the second person's copy. The portable memory device reads the activated RFIDs and stores the IDs in internal storage for determination of a link that provides online contents associated with the second person. By using the RF communication mechanism, a person can collect the links associated with the students of a class in addition to, or in place of, the embedded IDs associated with each photo.

It is understood that the games described above may be applicable to other printed documents such as tests, workbooks, books, textbooks and forms, which include printed features to allow physical interactions with a user. The user's physical interaction with the printed document is recorded, as scores, elapsed time, a sequence of IDs, etc., in the portable memory device for transmission to an online content server pointed to by a link determined by the portable memory device or a management server. The online content server collects statistics and provides additional information to the user.

FIG. 4 is a diagram of a network environment in which a printed document system 400 may operate. In FIG. 4, the printed document system 400 is shown to include a portable memory device 401, a computing device 402, a management server 403 and multiple online content servers 404. One of ordinary skill in the art would understand that any number of the portable memory devices, computing devices, management servers and online content servers can be used in connection with the system.

In an embodiment where the management server 403 is used, the management server 403 can be used to serve as an intermediary between the computing device 402 and the online content servers 404. The management server 403 is coupled to the computing device 402 and the online content servers 404 over a network 406. The management server 403 includes an application that decodes the data transmitted from the portable memory device 401 via the computing device 402 into a link. The data to be decoded includes the IDs (e.g., a master ID of a book, page IDs, zone IDs, portable memory device ID, and a combination of switches touched by a user). The management server 403 maintains a lookup data structure, such as a table, that translates the IDs and/or other information in the data into a link to a matching online content server. The management server 403 then transmits the link back to a browser 422 on the computing device 402, or redirects the user to the site pointed to by the link.

In an embodiment where the management server 403 is not used, the portable memory device 401 has the built-in capability to decode the collected data to obtain a link. The link is used by the browser 422 on the computing device 402 to receive online content. To simplify the discussions, the following descriptions will be directed to an embodiment in which the management server 403 is not used and the portable memory device 401 directly decodes the printed document data output to determine a link.

The network 406 can be any type of network including a public network (e.g., Internet), a private network (e.g., Ethernet, a Local Area Network (LAN), or a wide area network (WAN)), or similar networks. The network 406 can include any number of wired or wireless components.

The portable memory device 401 can be in any number of forms that are readily portable. The portable memory device 401 captures output data from a printed document via a ‘quick-touch’ or ‘quick-click’ capture mechanism on the device 401 that can be activated by a user's touching or clicking actions. The output data from a printed document is stored in an internal data storage device 405 of the portable memory device 401.

The portable memory devices 401 can be distributed to any number of users. Each user can use his portable memory device 401 with his own computers or with any other computers. Any number of organizations that offer online content services can offer their own set of portable memory devices 401 or can collaborate with one another to utilize the same set of portable memory devices 401. Each organization may provide its own web server to interact with the portable memory devices 401, or a set of web servers for multiple organizations may be administered by a third party.

The portable memory device 401 includes a controller and internal data storage. The portable memory device 401 also includes a set of communication devices to enable communication with other devices, such as printed documents, computers and external sensors/transmitters, to receive data and transmit stored content. The communication devices may include a direct Universal Serial Bus (USB) port or similar physical communication mechanism, a wireless communication mechanism (e.g. a radio frequency (RF) communication mechanism), or other similar communication mechanisms. In one embodiment, the portable memory device 401 may be embedded with an RF reader to read an RFID in a printed document.

The portable memory device 401 can be designed for a particular type of printed document (e.g., a comic book, photo album, year book, catalog, newspaper, magazine, form, test, textbook, game board, or other types of documents). A person may own multiple portable memory devices 401, each for a different type of printed content. The portable memory device 401 will be described in greater detail in connection with FIGS. 4-7.

The computing device 402 can be any type of device that provides a connection to the online content servers 104. The computing device 402 includes a desktop computer, workstation, laptop, console device, wireless device, handheld device, mobile phone or similar computing or multi-functional device capable of executing a general purpose application (e.g., a web browser) that can facilitate contact with the online content servers 404 over the network 406. The computing device 402 can execute any number of applications and can rely on any type of operating system. A general purpose application such as the browser 422 is utilized by the user of the portable memory device 401 to access and display online content on the display of the computing device 402.

The online content server 404 maintains online content and provides the online content to the user. The online content server 404 may also maintain a user account for tracking the user's scores, habits, or other personal data. The online content server 404 interprets the data received from the portable memory device 401 (e.g., a master ID of a book, page IDs, zone IDs, portable memory device ID, and a combination of switches touched by a user), and retrieves associated content stored in a database or similar data management structure. One of ordinary skill in the art would understand that the types of online content managed by the online content server 404 can be any of those contents that are associated with the printed documents, such as advertisements, scores, personal data, social networking information, educational materials, games, hobbies, and other information.

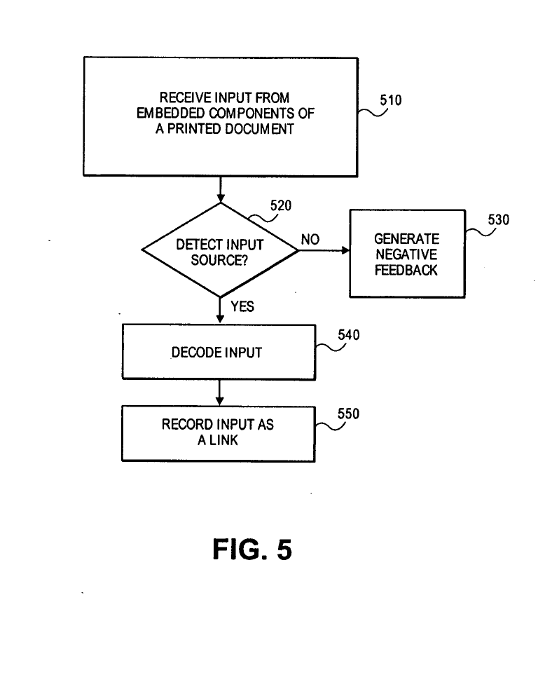

FIG. 5 is a flow diagram showing one embodiment of a process for the portable memory device 401 to collect data from a printed document. The portable memory device 401 is placed on a pre-determined spot on the printed document. The process starts when a user clicks the portable memory device 401 to start recording an input from embedded components in the printed document (e.g., circuit elements printed with resistive ink or RFID tags) (block 510). The user selects one or more points, fields, zones, buttons or other selectors on the printed documents to indicate an answer, an interest, or a request. In one embodiment, the user can click the portable memory device 401 at the same time a user selection is made. In an alternative embodiment, the portable memory device 401 continues monitoring the user selection once the recording is started. The portable memory device 401 determines whether an input source (i.e., a selected item) has been detected (block 520). If an input source cannot be detected (or a location of the input source cannot be determined), the portable memory device 401 generates negative feedback (block 530), for example, by generating a blinking red light. If an input source is detected, the portable memory device 401 decodes the received input to determine a link to an online content service associated with the printed document (block 540). The portable memory device 401 can also generate a positive feedback, (for example, by generating a blinking green light) when an input source is detected. The portable memory device 401 then records the decoded input as the link (block 550). Alternatively, the positive and negative feedback can be made by an embedded speaker in the portable memory device 401 that generates beeping sounds or other types of sounds.

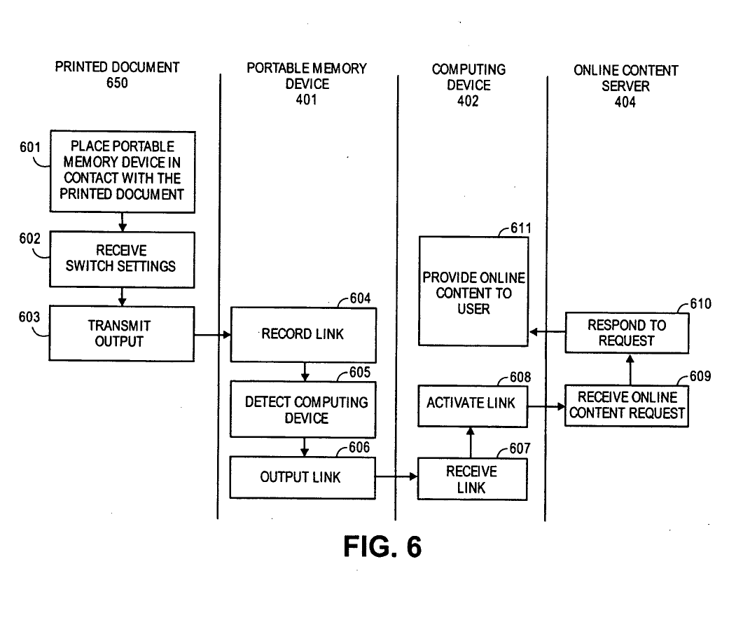

FIG. 6 is a diagram that illustrates one embodiment of a process for exchanging data among a printed document 650, the portable memory device 401, the computing device 402 and the online content servers 104. The process begins when the portable memory device 401 is placed in contact with the printed document 650 (block 601). The printed document 650 receives switch settings selected by a user of the portable memory device 401 (block 602). In response to the selected switch settings, the printed document transmits an output to the portable memory device 401 (block 603). The portable memory device 401 receives the output from the printed document 601 and decodes it into a link (block 604). The link points to a web page hosted by one of the online content servers 404. In one embodiment, the link is a uniform resource locator (URL).

When the portable memory device 401 is connected to the computing device 402, through a physical mechanism (e.g., a USB port), a wireless mechanism or other mechanisms, the portable memory device 401 detects the presence of the computing device 402 (block 605). In response to the detection, the portable memory device 401 sends the link encoded with IDs (e.g., a master ID of a book, page IDs, zone IDs, portable memory device ID, and a combination of switches touched by a user) to the computing device 102 (block 606). A browser may be launched on the computing device 102 to display the online content pointed to by the link. In an alternative embodiment, the online content may be provided to the user through the computing device 102 without a browser.

The computing device 402 receives the link and the other transmitted data from the portable memory device 401 (block 607). After receiving the transmitted data, the computing device 402 activates the link (block 608) to contact the online content server 404 pointed to by the link. The online content server 404 receives the online content request from the computing device 402 (block 609), and responds to the request by sending the requested online content to the computing device 402 (block 610). The computing device 402 then provides the online content to the user (block 611).

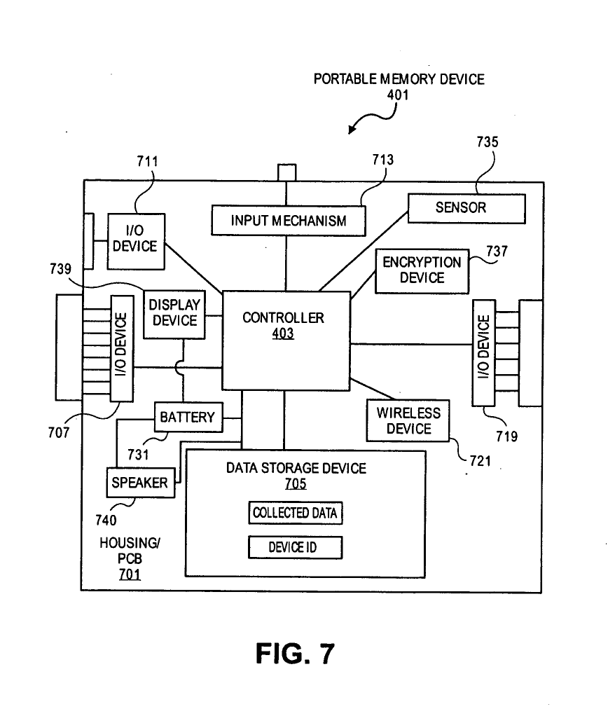

FIG. 7 is a diagram of one embodiment of the portable memory device 401 shown in FIG. 4. In one embodiment, the portable memory device 401 is composed of a printed circuit board (PCB) 701 within a housing or similar substrate within a similar packaging. In other embodiments, any number of the components of the portable memory device 401 may be on separate substrates or not attached to substrates. The portable memory device 401 can have any shape or size. In one example embodiment, the portable memory device 401 has a form factor of a memory stick that is roughly rectangular with a length between one inch and three inches, a width between 0.1 inches and two inches and a depth between 0.1 inches and one inch. This form factor is provided by way of example and for the sake of clarity in describing an embodiment of the invention. Other example form factors are described below and one skilled in the art would understand that the principles and features of the described embodiments are applicable to other shapes, form factors and sizes.

The portable memory device 401 includes a controller 703. The controller 703 manages data I/O and the storage of data in data storage 705. The controller 703 can be an application specific integrated circuit (ASIC), a general purpose processor or a similar processor or controller. The controller 703 manages the movement of data between the other components of the portable memory device 401 and also drives the other components of the portable memory device 401. In one embodiment, the controller 703 incorporates some or all of the other components of the portable memory device 401. For example, the controller 703 can include a data storage device 705, an I/O device 707 or similar components.

The portable memory device 401 includes at least one storage device 705. The storage device 705 can be any type of persistent storage device. The persistent storage device 705 can be an electronically erasable programmable read only memory (EEPROM) storage device, a static random access memory (SRAM) device or similar persistent storage device. The storage device 705 can be any size and hold any amount of data depending on the type and characteristics of the storage device. In another embodiment, additional storage devices of any type or size can be included. The additional storage devices can be used to store different types of data, provide additional space, or facilitate a simpler design. For example, separate storage devices can be tied to separate input mechanisms, to be output by the portable memory device 401 on selection of a corresponding input through an input mechanism 713.

The storage device 705 can store any type of content, links, digital assets, data structures or similar types of data. In one embodiment, the storage device 705 stores data collected from a printed document, a device ID that identifies the portable memory device 401, and may additionally store user account data, which uniquely identifies a user account on the online content server 404. The user account data may also include a user profile, such as an age group, hobbies, affiliations, other data that has been pre-programmed by the company distributing the portable memory device 401, or data that is entered by the user. The storage device 705 maintains these data entries as part of a standard file system or file directory.

The portable memory device 401 may also include a battery 731. Any type of battery including an alkaline, lithium, ion, nickel cadmium, nickel metal hydride or similar type of battery can be utilized. The battery 731 provides a power source for the portable memory device 401. In another embodiment the battery 731 can be replaced or assisted by other power sources such as external power sources, photovoltaic cells or similar power sources. The housing may be configured to allow easy replacement of the battery 731.

The portable memory device 401 can include any number of communication ports or input devices 707, 719 and 711. A first I/O device 707 can be any type of communication port, protocol or medium. The first I/O device 707 can be a universal serial bus (USB) port, fire wire port, serial port, parallel port or similar communications port. The first I/O device 707 can be connected to any type of physical connector or dongle. The connector can be a male or female connector such as a male or female USB connector. In one embodiment, the second I/O device 719 can be the same type of communication port, controller, protocol or connector as the first IO device 707. The second I/O device 719 can be a different type of controller including a proprietary type of connector. For example, the second I/O device 719 may control a specialized physical connector that communicates over a set of contact pads with other devices that have a complementary set of contact pads. In one example embodiment, these contact pads are oriented in a particular shape that requires the complementary pads to be properly aligned. For example, the shape of the contacts pads can be Y-shaped such that another portable memory device or computing device that communicates through the specialized communication system must align its contact pads, having a complementary Y-shape, to create a communication link between the two portable memory devices

A third I/O device 711 can provide an alternative communication medium, connector type or protocol from the first I/O device 707 and the second I/O device 719. For example, the first and second I/O devices 719 and 707 may primarily utilize physical connections. The third I/O device 711 can be a wireless connection mechanism such as RF or infra-red (IR), or a physical connection type dedicated to a specific device such as a handheld device, cellular communication device or similar device. The third I/O device 711 can be any type of communication port, connector, or communication protocol.

In one embodiment, any of the I/O devices 707, 719 and 711 of the portable memory device 401 can be implemented as a wireless device 721. The wireless device 721 can be any type of wireless device including a Bluetooth, 802.11 b/g/n, IR or similar type of wireless communication device. All of the I/O devices can be utilized to transfer and receive data to and from other electronic devices, including other portable memory devices, personal computers, console devices, handheld gaming devices, cellular communication devices and similar electronic devices.

In one embodiment, the portable memory device 401 includes an input mechanism 713. The input mechanism 713 can be any type of physical input mechanism connected to the electrical components of the portable memory device 401 to generate electrical signals to be input into the controller 703 or other components of the portable memory device 401. The input mechanism 713 can be a set of switches, sliders, buttons, dials, touch pads or similar input mechanisms. These input mechanisms can be used individually or in combination to generate input signals that are processed by the controller 703. The input signals can be processed to select specific data entry in the storage device 705.

The portable memory device 401 can include a sensor 735. The sensor 735 can be any type of detection or sensing device. The sensor 735 can be used to detect any non-digital input such as an electro-magnetic, kinetic, energy, light, mechanical or similar force. The sensor 735 can be a resistor, conductive ink, voltmeter, ammeter, ohmmeter, thermometer, photo detector or similar sensor. The sensor 735 can sample or similarly receive the non-digital input to generate an analog value or digital value representing the non-digital input. The sensor 735 can include an analog to digital (A/D) converter or an analog signal may be passed to the controller 703 or separate analog or digital converter. The controller 703 then converts or receives a digital representation of the non-digital input. This non-digital input can be used to modify existing data or can be stored as new data.

The portable memory device 401 can include an encryption device 737. The encryption device 737 provides security to the portable memory device 401 by encrypting and decrypting data transmitted to or from the portable memory device or within the portable memory device. In another embodiment, the encryption device 737 is a subcomponent of the controller 703. The encryption device 737 also facilitates the management of any protected data managed by the controller 703. The encryption device 737 and the controller 703 can confirm the transfer or deletion of data stored in the data storage device 705. This functionality can be utilized to prevent misuse of the portable memory device to dupe the online content server site. For example, a malicious user may attempt to obtain a higher ranking in a game than he is entitled to by preventing the clearing of score information from the data storage device 705

In one embodiment, the portable memory device 401 can include a display device 739. The display device 739 can be any type of display device including a cathode ray tube (CRT), liquid crystal display (LCD), light emitting diode (LED) or similar display type. The display device 739 can include a graphics controller or the controller 703 can drive the display device 739. The portable memory device 401 can include any number or size of display devices 739. The display device 739 can provide any resolution and color range including black and white or gray scaled graphics.

In one embodiment, the portable memory device 401 can include a speaker 740. The speaker 740 can be any type of speaker, such as an electro-acoustic transducer, which converts electrical signals into audible sounds. The speaker 740 receives signals from the controller 403 and converts the signals into sounds to be heard by the user.

In one embodiment, the interactive printed document system including the online content servers, the computing device and the portable memory device and the associated components are implemented as hardware systems and devices. In another embodiment, some of the components in the system are implemented as software (e.g., microcode, assembly language or higher level languages) stored on a computer-readable medium. A “computer-readable” medium may include a computer readable storage medium and any medium that can store or transfer information. Examples of a machine readable medium include a ROM, a floppy diskette, a CD-ROM, a DVD, flash memory, hard drive, an optical disk or similar medium.

In the foregoing specification, the invention has been described with reference to specific embodiments thereof. It will, however, be evident that various modifications and changes can be made thereto without departing from the broader spirit and scope of the invention as set forth in the appended claims. The specification and drawings are, accordingly, to be regarded in an illustrative rather than a restrictive sense.

What is claimed is:

1. A method comprising:
receiving an input from an embedded element of a printed document; and
recording the input in a memory of a portable memory device as a link to on-line content.

2. The method of claim 1, wherein the input is received through resistive ink or a radio frequency identifier.

3. The method of claim 1, wherein the printed document is a comic book, photo album, year book, catalog, newspaper, magazine, form, test, textbook, or game board.

4. The method of claim 1, wherein the input identifies a location in the printed document.

5. The method of claim 1, further comprising:
initiating the recording in response to a user request.

6. The method of claim 1, further comprising:
displaying an indicator, through a display device of the portable memory device, that the input has been recorded.

7. The method of claim 1, further comprising:
transmitting the link in response to a connection with a computing device.

8. The method of claim 1, wherein the input indicates a combination of activated switches in the printed document.

9. The method of claim 1, wherein the input provides game status data.

10. A system comprising:
a printed document to define an embedded output component to transmit a link to on-line content; and
a portable memory device removably coupled to the printed document to record the link.

11. The system of claim 10, wherein the portable memory device includes a feedback display.

12. The system of claim 10, wherein the portable memory device includes an activated mechanism to initiate recordation of the link.

13. The system of claim 10, wherein the printed document defines a set of switches to determine an output value.

14. A computer-readable storage medium, having instructions stored therein, which when executed cause a computer to perform a set of operations comprising:
receiving an input from an embedded element of a printed document; and
recording the input in a memory of a portable memory device as a link to on-line content.

15. The computer-readable storage medium of claim 14, wherein the input is received through resistive ink or a radio frequency identifier.

16. The computer-readable storage medium of claim 14, wherein the printed document is a comic book, photo album, year book, catalog, newspaper, magazine, form, test, textbook, or game board.

17. The computer-readable storage medium of claim 14, wherein the input identifies a location in the printed document.

18. The computer-readable storage medium of claim 14, having further instructions stored therein, which when executed cause a computer to perform a set of operations further comprising:
initiating the recording in response to a user request.

19. The computer-readable storage medium of claim 14, having further instructions stored therein, which when executed cause a computer to perform a set of operations further comprising:
displaying an indicator, through a display device of the portable memory device, that the input has been recorded.

20. The computer-readable storage medium of claim 14, wherein the input indicates a combination of activated switches in the printed document.
